(19) United States
(12) Patent Application Publication
(10) Pub. No.: US 2012/0149790 A1
(43) Pub. Date: Jun. 14, 2012

(54) RECYCLED BUILDING MATERIAL AND METHOD THEREOF

(76) Inventor: L. Richard PENG, Fishers, IN (US)

(21) Appl. No.: 13/400,335

(22) Filed: Feb. 20, 2012

Related U.S. Application Data
(63) Continuation of application No. 12/781,863, filed on May 18, 2010.
Application No. 12/781,863 is a continuation of application No. 11/724,768, filed on Mar. 16, 2007, now abandoned.

(51) Int. Cl. C08L 37/00; C08J 11/04

(52) U.S. Cl. 521/47; 525/208; 521/149

(57) ABSTRACT

The present invention provides a recycled building material such as roof/Geo membrane that comprises (i) a polyolefin, (ii) a polymer containing a carboxyl group or a hydroxyl group, and (iii) a compatabilizer for the components (i) and (ii) which contains an epoxy group or an anhydride group. The present invention also provides a method of recycling building material as well as an article of manufacture such as a TPO membrane using the recycled building material. The TPO membrane has gained better physical properties such as consistent product quality, tensile strength, tear strength, wind resistance, and avoidance of tedious screening processes, among others.

This application is a continuation of U.S. Non-Provisional application Ser. No. 12/781,863, filed on May 18, 2010, which is a continuation of U.S. Non-Provisional application Ser. No. 11/724,768, filed on Mar. 16, 2007, which are incorporated herein by reference.

### BACKGROUND OF THE INVENTION

The present invention is directed to a recycled building material such as roof/Geo membrane and an article of manufacture such as a TPO membrane that is made from the recycled building material. Moreover, the present invention provides a method of recycling building material. The TPO membrane has gained better physical properties such as consistent product quality, tensile strength, tear strength, wind resistance, and avoidance of tedious screening processes, among others.

A tremendous amount of building material such as thermoplastic polyolefins (TPO) has been used in, for example, roof/Geo membrane. Recycling and reutilization of such building material is not only financially cost-effective, but also it is very beneficial for environment protection. However, in recycling thermoplastic polyolefin sheets that are reinforced with fabric such as polyester fiber, it is often difficult to obtain a recycled product with desired mechanical properties. For example, PET fiber from the scrim for TPO membrane reinforcement is highly incompatible with the TPO compound used for the top ply and the bottom ply. Despite that many combinations of screening equipments are used to remove the PET fibers prior to recycling, a certain amount of the fibers still remains and can not be completely removed. The PET leftover and TPO may form immiscible phases, which cause low tear problem on finished product. Moreover, the PET leftover can react with certain filler treatment and form big particles in a re-melting process. These particles may also cause problems such as inconsistent quality, and low tensile strength, among others.

Advantageously, the present invention provides a recycled building material and method thereof that can solve the above problems. With improved mechanical properties such as consistent product quality, tensile strength, tear strength, and wind resistance etc., the recycled building material of the present invention may be reutilized in many industrial applications.

### SUMMARY OF THE INVENTION

One aspect of the present invention is to provide a recycled building material that comprises (i) a polyolefin, (ii) a polymer containing a carboxyl group or a hydroxyl group, and (iii) a compatabilizer for the components (i) and (ii) which contains an epoxy group or an anhydride group.

A second aspect of the present invention is to provide an article of manufacture such as a TPO membrane that is made from the recycled building material comprising (i) a polyolefin, (ii) a polymer containing a carboxyl group, a nylon (amide) group, or a hydroxyl group, and (iii) a compatabilizer for the components (i) and (ii) which contains an epoxy group or an anhydride group.

A third aspect of the present invention is to provide a method of recycling building material such as roof/Geo membrane.

Other aspects of the invention may be appreciated from the following detailed description.

### BRIEF DESCRIPTION OF THE DRAWINGS

The invention may take form in various components and arrangements of components, and in various steps and arrangements of steps. The drawings, wherein like reference numerals denote like components throughout the several views, are only for purposes of illustrating preferred embodiments and are not to be construed as limiting the invention.

In the drawings appended hereto:

FIG. 1 shows the relationship between temperature and mixing torque of a formulation comprising no compatabilizer.

FIG. 2 shows the relationship between temperature and mixing torque of a formulation of the invention that comprises a compatabilizer.

### DETAILED DESCRIPTION OF ILLUSTRATIVE EMBODIMENTS

It is to be understood herein, that if a “range” or “group” is mentioned with respect to a particular characteristic of the present invention, for example, ratio, percentage, chemical group, and temperature etc., it relates to and explicitly incorporates herein each and every specific member and combination of sub-ranges or sub-groups therein whatsoever. Thus, any specified range or group is to be understood as a shorthand way of referring to each and every member of a range or group individually as well as each and every possible sub-range or sub-group encompassed therein; and similarly with respect to any sub-ranges or sub-groups therein.

As one of its aspects, the present invention provides a recycled building material that comprises (i) a polyolefin, (ii) a polymer containing a carboxyl group or a hydroxyl group, and (iii) a compatabilizer for the components (i) and (ii) which contains an epoxy group or an anhydride group.

In general embodiments of the invention, the polyolefin, the polymer containing a carboxyl group or a hydroxyl group, and the compatabilizer in the recycled building material form a homologous or distributive mixture with no phase separation.

In a variety of exemplary embodiments, the polyolefin may be a polymer or copolymer that comprises, for example, polyethylene, polypropylene, polybutene or polybutylene, polyisobutylene, poly(4-methyl-1-pentylene), chlorinated and chlorosulphonated polyethylenes, polyhexene, ethylene/propylene copolymer such as EPM and EPDM, ethylene/1-butene copolymer, ethylene/4-methyl-1-pentene copolymer, ethylene/1-hexene copolymer, ethylene/1-octene copolymer, ethylene/1-decene copolymer, propylene/1-butene copolymer, propylene/1-hexene copolymer, propylene/4-methyl-1-pentene copolymer, 1-butene/4-methyl-1-pentene copolymer, 1-butene/1-hexene copolymer, and mixture thereof.

In specific embodiments, the polyolefin may be selected from thermoplastic polyolefins (TPO) such as thermoplastic polyethylene, thermoplastic polypropylene, copolymer thereof, or mixture thereof.

The polyolefin may comprise commercial products such as Basell CA10A, Basell KS311P, Spartech FR-7059, flame retardants, UV stabilizers, antioxidants, pigments, antiblock agents, and the mixture thereof. Basell CA10A and Basell KS311P are in-reactor TPO blend made by the unique Catalloy process. Spartech FR-7059 is a concentration which includes all the ingredients except the TPOs. It uses small amount of resin as the carrier to bind everything in pellet form.

In a variety of exemplary embodiments, off-specification building material such as roof/Geo membrane may be used as the polyolefin of the invention.

Based on the total weight of the recycled building membrane, the amount of the polyolefin may be from about 40% (wt) to about 95% (wt), preferably from about 50% (wt) to about 92% (wt), and more preferably from about 55% (wt) to about 90% (wt).

In a variety of exemplary embodiments, the polymer containing a carboxyl group or a hydroxyl group may be selected from a polymer or copolymer of polyester.

In a variety of exemplary embodiments, the component (ii) polymer may be a polyester such as poly(alkylene terephthalate). Examples of poly(alkylene terephthalate) includes, but are not limited to, poly(ethylene terephthalate) (PET), poly(1,4-butylene terephthalate) (PBT), poly(1,3-propylene terephthalate) (PTT), poly(1,5-pentylene terephthalate), poly(1,6-hexylene terephthalate), poly(1,7-heptylene terephthalate), poly(1,8-octanylene terephthalate) poly(1,4-cyclohexylenedimethylene terephthalate) (PCT), copolymer thereof, and mixture thereof.

In specific embodiments, the component (ii) polymer is selected from commercial product such as PET weft inserted scrim for membrane reinforcement, PBT scrim, and the like. An example of the PET used for the scrim is Invista 1000 denier Type 787 from Kosa.

In a specific embodiment, the component (ii) polymer comprises poly(ethylene terephthalate) (PET) as shown below:

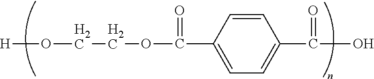

in which n may be within a range from about 100 to about 200, preferably within a range from about 125 to about 175, and more preferably within a range from about 130 to about 150; and/or Nylon of the formula:

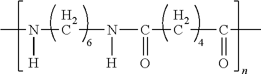

in which n is an integer.

In a variety of exemplary embodiments, the poly(ethylene terephthalate) may be those reinforced fibers used in off-specification building material such as roof/Geo membrane.

Based on the total weight of the recycled building material, the amount of the polymer containing a carboxyl group or a hydroxyl group may be from about 3% (wt) to about 10% (wt), preferably from about 4% (wt) to about 8% (wt), and more preferably from about 4.5% (wt) to about 7.5% (wt).

The compatabilizer of the invention comprises at least two structural moieties in its molecule. The first structural moiety comprises at least one epoxy group or anhydride group, and the second structural moiety is miscible with the polyolefin component of the recycled building material, as described supra. In a variety of exemplary embodiments, the compatabilizer is a polymer with a chemical structure comprising a polyolefin such as a polyethylene and polypropylene as at least part of its backbone and/or side chain(s). The compatabilizer can react with the component (ii) polymer such as polyester (e.g. PET) on one side and entangle with the polyolefin such as TPO chains on the other side. Preferably, the polyolefin, the polymer containing a carboxyl group or a hydroxyl group, and the compatabilizer form a homologous mixture with no phase separation in the recycled building material.

For example, the reaction between a polymer containing a carboxyl group and an epoxy-containing compatabilizer may be an epoxy open ring reaction as illustrated below:

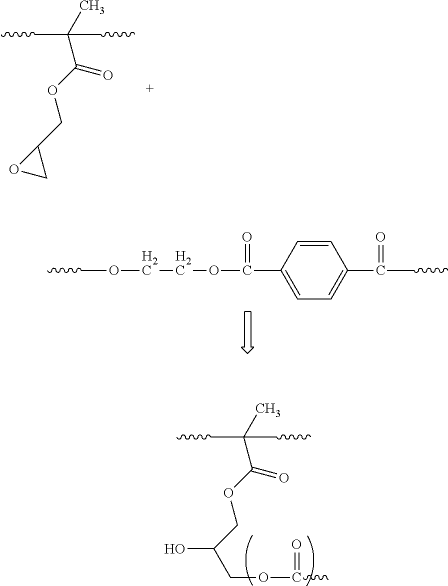

In an embodiment, the compatabilizer may comprise poly(conjugated diene) and anhydride groups, for example, polybutadiene maleic anhydride (PBDMA); and the component (ii) polymer comprises a hydroxyl group, for example, PET. The anhydride group will react with the hydroxyl group to form an ester, and on the other hand, the poly(conjugated diene) portion such as polybutadiene may entangle with polyolefin such as TPO. Such compatabilizers may be obtained commercially, for example, Ricobond 1756 from Ricon Resins Inc., or LOTADER 3300 resin, which is a random terpolymer of ethylene (E), ethyl acrylate (EA) and maleic anhydride (MAH). Specific examples of conjugated dienes include, but are not limited to 1,3-butadiene (1,3-Bd), isoprene (2-methyl-1,3-butadiene), 2-ethyl-1,3-butadiene, 2,3-dimethyl-1,3-butadiene, piperylene (1,3-pentadiene), 2-methyl-1,3-pentadiene, 3-methyl-1,3-pentadiene, 4-methyl-1,3-pentadiene, 2,4-dimethyl-1,3-pentadiene, 1,3-hexadiene, and the like, and the mixture thereof.

In an embodiment, the compatabilizer comprises polybutadiene maleic anhydride (PBDMA); and the component (ii) polymer comprises PET (polyester fiber) with hydroxyl groups and optional polyethylene (PE) chain; or Nylon (PA). The reactions between them can be illustrated below:

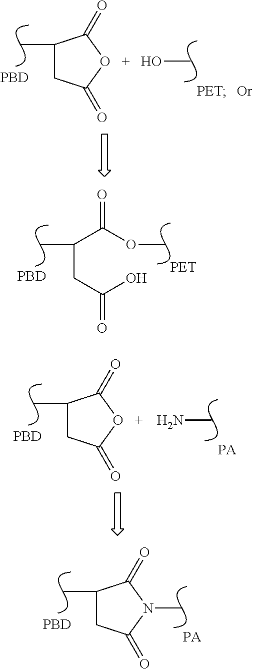

In a variety of exemplary embodiments, the compatabilizer may comprise a copolymer of olefin monomers and epoxy-containing monomers. Examples of olefin monomers include, but are not limited to, ethylene, propylene, butene or butylene, 1-butene, isobutylene, pentylene, 4-methyl-1-pentylene, hexene, heptene, octane, decene, and the like, and the mixture thereof. Examples of epoxy-containing monomers include, but are not limited to, glycidyl acrylate, glycidyl methacrylate, methyl glycidyl acrylate, methyl glycidyl methacrylate, 3,4-epoxycyclohexylmethyl acrylate, 3,4-epoxycyclohexylmethyl methacrylate, acrylic glycidyl ether, methacrylic glycidyl ether, and the like, and mixtures thereof. In embodiments, the compatabilizer may be selected from olefin/glycidyl (meth)acrylate copolymer such as ethylene/glycidyl methacrylate co-polymer.

Optionally, other monomers may also be copolymerized with the olefin monomers and epoxy-containing monomers in order to increase the flexibility and toughness of the final compound. Examples of such monomers include, but are not limited to, alkyl (meth)acrylates such as methyl acrylate, methyl methacrylate, ethyl acrylate, ethyl methacrylate, propyl acrylate, propyl methacrylate, butyl acrylate, butyl methacrylate, pentyl acrylate, pentyl methacrylate, hexyl acrylate, hexyl methacrylate, ethylhexyl acrylate, ethylhexyl methacrylate, and the like, and the mixture thereof.

In a variety of exemplary embodiments, the compatabilizer is selected from the group consisting of a ter-polymer of ethylene/methyl acrylate/glycidyl methacrylate (EMAGMA), a ter-polymer of ethylene/ethyl acrylate/glycidyl methacrylate (EEAGMA), a ter-polymer of ethylene/butyl acrylate/glycidyl methacrylate, a ter-polymer of ethylene/ethylhexyl acrylate/glycidyl methacrylate, and the like, and mixtures thereof.

In a specific embodiment, the compatabilizer comprises a poly(ethylene-co-methyl acrylate-co-glycidyl methacrylate) (EMAGMA) as shown below:

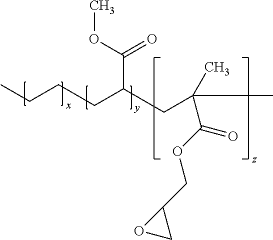

in which x units may be within a range from about 65 wt % to about 95 wt %, y units may be within a range from about 0 wt % to about 30 wt %, and z units may be within a range from about 0 wt % to about 8 wt %, based on the total weight of the copolymer. In an embodiment, the above z units may be replaced by maleic anhydride unit, the range of which is from 0 wt % to 4 wt %, based on the total weight of the copolymer.

The epoxy-containing compatabilizer may be commercially available, such as the Lotader GMA products marketed by Elf Atochem (Elf Atochem, North America, Inc., Philadelphia, Pa.) as Lotader AX-8900 (E-MA-GMA, MI=6), Lotader AX8660 (E-EA-GMA), Lotader AX 8930, Lotader AX 8840, and the like.

Based on the total weight of the recycled building material, the amount of the compatabilizer may be from about 1 wt % to about 10 wt %, preferably from about 2.5 wt % (wt) to about 7.5 wt % (wt), and more preferably from about 3 wt % (wt) to about 5 wt % (wt).

In a variety of exemplary embodiments, the molar ratio between the carboxyl group(s) from the component (ii) polymer and the epoxy group(s) from the epoxy-containing compatabilizer may be controlled to be within the range of about 1:2. For example, the carboxyl group(s) from the component (ii) polymer may be stoichiometrically equivalent (about 1:2) to the epoxy group(s) from the epoxy-containing compatabilizer, so as to gain a high efficiency in compatiblizing between the component (ii) polymer and the polyolefin.

In an embodiment, the compatabilization is maximized by uniformly distributing and mixing PET fiber and the TPO compound during feeding into the continuous mixer such as a twin screw extruder.

As one of its aspects, the present invention provides an article of manufacture that is made from a recycled building material. The recycled building material comprises (i) a polyolefin, (ii) a polymer containing a carboxyl group or a hydroxyl group, and (iii) a compatabilizer for the components (i) and (ii) which contains an epoxy group or an anhydride group. In a variety of exemplary embodiments, the polyolefin, the polymer containing a carboxyl group or a hydroxyl group, and the compatabilizer may be selected from those as described supra.

In various exemplary embodiments, the article of the invention is a TPO membrane comprising a recycled building material such as a recycled TPO. For example, the invention may be used to recycle off grade polyolefin membrane reinforced by polyester or polyamide scrim back to any ply of the membrane.

Depending on the thickness of the recycled membrane, the total weight of the recycled TPO compound may be from about 85% (wt) to about 95% (wt) in the recycled material.

As one of its aspects, the present invention provides a method of recycling building material that comprises the steps of

(i) providing a first building material comprising a polyolefin,

(ii) providing a second building material comprising a polymer containing a carboxyl group or a hydroxyl group,

(iii) providing a compatabilizer which contains an epoxy group or an anhydride group for the polyolefin and the polymer containing a carboxyl group or a hydroxyl group, and

(iv) melting and mixing the first building material, the second building material, and the compatabilizer.

The first and second construction materials are meant to encompass a wide variety of materials which can generally be described as being composed predominantly of an organic substance of large molecular mass, which is solid or semi-solid in its finished state at standard temperature and pressure, but at some point in its manufacture or processing can be shaped by flow. Typically, many of such materials are polymeric and are usually thermoplastic. These materials can be molded, cast, extruded, drawn, coated onto a substrate or laminated into various shapes and objects such as, beads, powders, films, fibers, plates, filaments or rods.

In a variety of exemplary embodiments, the first building material and the second building material may be obtained from the same construction system. For example, the first building material may be TPO compound used for the top ply and the bottom ply in a roof, while the second building material may be PET fibers from the scrim for TPO membrane reinforcement.

In many cases, the first building material and the second building material are preferably separated as completely as possible in the first place. For example, any existing separation processes may be employed to clean the polyester fiber from a TPO product. Pre-screening processes using granulizer, elutriator, shredder cyclone or the like may be suitable to remove the fiber. Combinations of screening equipments may also be contemplated. In an exemplary embodiment, TPO stripped membrane or shredded membrane is used in the method of the invention. In preferred embodiments, tedious screening processes are avoided due to the high efficiency of the method.

However, in many cases, the first building material and the second building material are difficult to be separated completely, and both materials have to coexist in the subsequent recycling process. The second building material such as PET fiber from the scrim for reinforcement of the first building material such as TPO membrane is highly incompatible with the TPO compound used for the top ply and the bottom ply. As such, a compatabilizer may be used during, for example, a melting process. This compatabilizer can react with carboxyl or ester group of the second building material e.g. PET on one hand and entangle the TPO chains of the first building material on the other hand.

In a variety of exemplary embodiments, the polyolefin of the first building material, the polymer of the second building material, and the compatabilizer may be those as described above.

In an exemplary embodiment of the invention, melting and mixing the first building material, the second building material, and the compatabilizer may be conducted in a mixing apparatus. The mixing apparatus may be selected from those known to a skilled person in the art that are able to obtain a homogeneous mixture of two or more reactants. Exemplary mixing apparatuses include, but are not limited to, a Brabender mixer or a Brabender plastograph, a two-stem mixer, a twin-screw extruder, a single-screw extruder, a plastomill or a rubber mill, a Banbury mixer, a Buss-Ko kneader, a Farrel continuous mixer, a Henschel mixer, a ribbon blender, a V-type blender, a mixing roll, a kneader, a static mixer, an impingement mixer, and the like.

The mixing apparatus may be so configured and equipped that it has one or more further functions selected from the group consisting of temperature control, torque control, start-stop controls, rotation speed control, reactor environment control, reactants feeding measurement and control, and the like, and any combination thereof. For example, the mixing apparatus may be equipped with a temperature control console which includes temperature sensors, cooling means and temperature indicators etc.; the mixing apparatus may also be equipped with a drive motor having variable speed and constant torque control, start-stop controls and ammeter. Also, the mixing apparatus may be equipped with a reactor environment control system that introduces an inert gas such as nitrogen to protect reactions occurring in the apparatus.

For example, sheets or membranes may be made utilizing the mixture of the first building material, the second building material, and the compatabilizer in an extruder. Preferably, this is done by injecting the inert gas into the molten mixture in the extruder which is equipped with a sheet forming die. The inert gas used in this process can be any gas which does not chemically react with the mixture at the elevated processing temperatures required. Some representative examples of inert gases which can be used include nitrogen, carbon dioxide, helium, neon, argon, and krypton. For purposes of cost savings, nitrogen, carbon dioxide, or mixtures thereof may preferably be used as the inert gas.

Sheets or membranes may be made with either a plasticating extruder or a melt extruder. For example, screw extruders may push the molten material through a metal die that continuously shapes the sheet into the desired form. In most cases, single screw extruders, twin screw extruders, or multiple screw extruders may be employed toward this end. Taking single screw extruder for an example, the mixture may be fed into the extruder by gravitational flow from a hopper into the screw channel. The mixture may be initially in particulate solid form, which enters the solid conveying zone of the extruder. In the solid conveying zone, the solid mixture may be conveyed and compressed by a drag-induced mechanism. In the solid conveying zone, the mixture is mixed, heated, and conveyed through the extruder toward the melting zone. This heating is provided by maintaining the barrel of the extruder at an elevated temperature. The barrel of the extruder is typically heated electrically or by a fluid heat exchanger system. Thermocouples are also normally placed in the metal barrel wall to record and to help control barrel temperature settings.

Melting occurs in the melting zone after the mixture is heated to a temperature which is above its melting point. In the melting zone, melting, pumping and mixing simultaneously occur. The molten mixture is conveyed from the melting zone to the melt conveying zone. The inert gas may be injected into the molten mixture in the melt conveying zone. In the melt conveying zone, pumping and mixing simultaneously occur. The molten mixture in the melt conveying zone is maintained at a temperature which is well above its melting point. A sufficient amount of agitation may be provided so as to result in an essentially homogeneous dispersion of inert gas bubbles throughout the molten resin. The molten material entering the melt conveying zone from the melting zone is at a somewhat lower temperature and accordingly is of a higher viscosity. This essentially prevents the inert gas from back mixing through the extruder and escaping from the solid conveying zone via the hopper.

The step (iv) melting and mixing may last until the desired product is generated. In an embodiment, the melting and mixing was conducted on a 60 mm, 42D twin screw extruder at a temperature of from about 250° C. to about 275° C. Other melting/mixing parameters may be determined depending upon the specific recycled materials and compatabilizers. For example, the extruder head pressure may be controlled at a value of from about 1000 psi to about 2000 psi; the rotation speed of a mixing apparatus may be controlled at a value of from about 200 rpm to about 300 rpm; and the feeding rate of reactants may be controlled at a value of from about 500 pounds/hour to about 750 pounds/hour.

In an exemplary embodiment of the invention, an epoxy-containing compatabilizer (EMAGMA) was used during melting process in a twin screw extruder to chemically and physically link two immiscible phases, for example, thermoplastic polyolefin sheets and polyester (PET) fabric that is used to reinforce the sheets.

Subsequent to step (iv), the molten mixture of the first building material, the second building material, and the compatabilizer may be used to form any finished product such as a TPO membrane. For example, the molten mixture in the melt conveying zone may be pumped into a metering pump and finally extruded through a die such as a sheet-forming die or a circular die. The metering pump and sheeting die are typically maintained at a lower temperature than that of the barrel surrounding the melt conveying zone to minimize rupture and diffusion of inert gas bubbles in the mixture. The sheeting die may be of a generally rectangular design which is quite wide and of a small opening. Upon exiting the sheeting die, the sheet extrudate will swell to a level which is dependent upon the melt temperature, the die length-to-opening ratio, and the shear stress at the die walls.

The present invention is able to provide numerous technical benefits, for example, consistent TPO product quality; improved tensile strength, tear strength, and wind resistance; avoidance of tedious screening processes; prevention of the big particles' formation in a recycled TPO product due to the reaction between leftover PET and fillers; among others.

The following examples are included to provide additional guidance to those skilled in the art in practicing the claimed invention. The examples provided are merely representative of the work that contributes to the teaching of the present application. Accordingly, these examples are not intended to limit the invention, as defined in the appended claims.

### EXAMPLES

### Example 1

A lab Brabender mixer was used to prepare two formulations as listed in Table 1. The formulation #1 was to simulate recycling membrane (repel) in an extruder. The formulation #2 was to simulate recycling membrane plus the compatabilizer in an extruder. In the formulations, the amount of each component was in weight %.

TABLE 1

| Repel Mixing | Formulation #1 | Formulation #2 |
|---|---|---|
| Basell CA10A | 46 | 46 |
| Basell KS311P | 31 | 31 |
| Spartech FR-7059 | 22 | 22 |
| PET Kosa yarns | 1 | 1 |
| AX-8900 (E-MA-GMA, MI = 6) | | 1 |

(Brabender Internal Mixer @275° C., 50 rpm till torque reaches steady state)

The mixtures after the torque reached steady state were taken to a twin roll mill to form slabs for compression molding. The mill temperature was 340° F. The moldings were set at 175° C., 400 psi for 5 minutes.

The physical testing results are listed in Table 2.

TABLE 2

| Physical Properties | Formulation #1 | Formulation #2 |
|---|---|---|
| Tensile strength, Tb@RT(psi) | 1817 | 2206 |
| Tensile Elongation, Eb@RT(%) | 570 | 658 |
| Tensile Energy @RT (lbf-in) | 89 | 106 |
| Tear Energy @RT (lbf-in) | 25 | 28 |

About 10% to 20% improvements were seen from this experiment. In this example, 1% of fiber and 1% of compatabilizer were added into the repel. When no fiber was removed out, the fiber content can be 10% maximum.

### Example 2

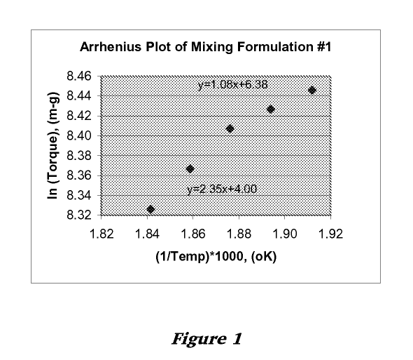

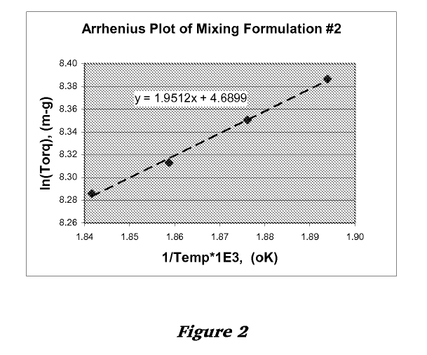

To study the melt flow influence by adding compatabilizer to the recycling membrane, Arrhenius plots were used to investigate the mixing conditions of both formulations #1 and #2. The results are shown in FIG. 1 and FIG. 2.

FIG. 1 shows the relationship between temperature and mixing torque of formulation #1 comprising no compatabilizer. With reference to FIG. 1, the line simulating the upper three data points and the line simulating the lower three crossover at a point with coordinate X=˜1.87. This suggests that the incompatible PET phase flew faster than the TPO when it melted at 260° C., i.e., when the 1/T is 1.87E⁻³oK⁻¹. FIG. 1 shows the flow mechanism changed and the PET flows like an external lubricant.

The two-phase flow behavior disappeared when the compatabilizer was added to the formulation. FIG. 2 shows the relationship between temperature and mixing torque of the formulation. As indicated in the Arrhenius plot of FIG. 2, the compound flew like one-phase flow.

The experiment proved that adding the compatabilizer can improve the compatibility between the TPO and the PET. The mechanical performance and the quality consistency of the recycled mixture were also improved.

### Example 3

### Plant Trial

The membrane to be recycled was first granulized. Then the pieces went through an elutriator and a cyclone to remove loose fiber not connecting to the TPO compounds. Afterward the pieces were fed to a single screw extruder to melt everything and form pellets by a die face cutter. The pellets were then dry blended with 1% compatabilizer (AX-8900) and re-extruded in the single screw extruder at the same condition as before. The final mixture was recycled 25% to the core ply and made into finished membrane. The mechanical properties of the membrane made were tested, and the results were listed in Table 3 below.

TABLE 3

| | | | MD | | Core |
|---|---|---|---|---|---|
| | MD Grab | TD | Tongue | Ply | Ash |
| Sampling | Tb | Grab Tb | Tear | Adhesion | (%) |
| Before Trial | 353 | 330 | 129 | 18.6 | |
| Near the start of trial | 359 | 331 | 150 | 19.2 | 9.16 |
| In trial | | 329 | 145 | 26.4 | |
| Near the end of trial | 367 | 335 | 151 | 16.9 | 9.27 |
| End of trial | 355 | 328 | 139 | 18.8 | 10.14 |

Table 3 shows that, when the compatabilizer treated repel was fed into the extruder, the MD Tongue Tear and TD Grab Tensile strength both increased. The ply adhesion may go up yet is not apparent. This result proves that adding compatabilizer can improve the quality of recycling TPO membrane with PET scrim reinforcement.

### Example 4

The membrane to be recycled was shredded in 0.5″ by 0.5″ size and fed into a twin screw extruder (TSX) by a belt feeder. It could also be stripped in certain size depending on the inlet opening of a single screw extruder. When the single screw melted everything, the melt was dropped into a twin screw extruder. A weighing belt was put in to transfer the melt and measure the input rate to the TSX. The compatabilizer was side fed and mixed with the melt. The weight of the compatabilizer to the melt transferred was from 1% to 3%. As for the TSX, the screw design before the side feeding completely melted the PET yet not heated up to exceed the decomposition temperature of the fillers. The mixing after the side feeding was more distributive than dispersive. A vacuum vent was preferred before the die cutting such that all the moisture from the fillers or the PET could be moved out.

The formulation in Table 4 is an example of recycling a TPO membrane on a 25 mm TSX.

TABLE 4

| | |
|---|---|
| Basell CA10A | 4.15 |
| Scrap TPO membrane | 30 |
| AX-8900 (E-MA-GMA, MI = 6) | 0.53 |
| HISII ABS | 0.32 |
| Total (lb/hr): | 35 |

Because the compatabilizer AX-8900 has low melting point, Basell CA10A and HiSil ABS were added to the compatabilizer to prevent the compatabilizer from sticking at the inlet. This formulation used 1.5% (wt) compatabilizer. The pellet collected from strand cut was first dried, then compression molded into a 45 mil plaques under 175° C., 4000 psi. The physical properties are listed below for comparison.

TABLE 5

| | No | 1.5% |
|---|---|---|
| Recycled TPO Membrane on TSX | compatabilizer | compatabilizer |
| Output Rate (lb/hr) | 35 | 35 |
| Hardness (Shore A), @RT | 95 | 93 |
| 100% Tensile Modulus @RT | 970 | 1133 |
| Tensile strength, Tb @RT(psi) | 1026 ± 9% | 1454 ± 5% |
| Tensile Elongation, Eb @RT(%) | 271 ± 50% | 522 ± 7% |
| Tensile Energy @RT (lbf-in) | 30 ± 50% | 64 ± 10% |
| Tensile Strength, Tb Aged (psi) | | 1492 |
| Tensile Elongation, Eb Aged(%) | | 467 |
| Die-C Tear strength @RT (PLI) | 339 ± 6% | 380 ± 3% |
| Tear Energy to break@RT (lbf-in) | 14.5 | 19.6 |
| Die-C Tear strength, Aged (PLI) | | 407 |

When the compatabilizer was used, there are several significant improvements including, for example, variation of the tensile properties was much lower. This means the bad dispersion from large particles formed by reaction between the magnesium hydroxide and the PET was greatly reduced. The performance became more consistent. Another exemplary improvement was that the tensile strength, ultimate elongation and tear strength all increased significantly (from 12% to 95%).

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims.

What is claimed is:

1. A recycled building material that comprises (i) a polyolefin, (ii) a polymer containing a carboxyl group, an amide group or a hydroxyl group, and (iii) a compatabilizer for the components (i) and (ii) which contains an epoxy group or an anhydride group.

2. The recycled building material according to claim 1, in which the polyolefin, the component (ii) polymer, and the compatabilizer form a homologous mixture with no phase separation.

3. The recycled building material according to claim 1, in which the polyolefin comprises a polymer or copolymer selected from the group consisting of polyethylene, polypropylene, polybutene or polybutylene, polyisobutylene, poly(4-methyl-1-pentylene), chlorinated and chlorosulphonated polyethylenes, polyhexene, ethylene/propylene copolymer such as EPM and EPDM, ethylene/1-butene copolymer, ethylene/4-methyl-1-pentene copolymer, ethylene/1-hexene copolymer, ethylene/1-octene copolymer, ethylene/1-decene copolymer, propylene/1-butene copolymer, propylene/1-hexene copolymer, propylene/4-methyl-1-pentene copolymer, 1-butene/4-methyl-1-pentene copolymer, 1-butene/1-hexene copolymer, and mixture thereof.

4. The recycled building material according to claim 1, in which the polyolefin is selected from thermoplastic polyolefins (TPO) such as thermoplastic polyethylene, thermoplastic polypropylene, copolymer thereof, or mixture thereof.

5. The recycled building material according to claim 1, in which the polyolefin is obtained from off-specification roof/Geo membrane.

6. The recycled building material according to claim 1, in which the amount of the polyolefin is from about 40% (wt) to about 95% (wt) based on the total weight of the recycled building material.

7. The recycled building material according to claim 1, in which the component (ii) polymer comprises a polyester, a polyamide, a copolymer of polyester, or a copolymer of polyamide.

8. The recycled building material according to claim 7, in which the polyester comprises a poly(alkylene terephthalate) or copolymer thereof.

9. The recycled building material according to claim 8, in which the poly(alkylene terephthalate) is selected from the group consisting of poly(ethylene terephthalate) (PET), poly(1,4-butylene terephthalate) (PBT), poly(1,3-propylene terephthalate) (PTT), poly(1,5-pentylene terephthalate), poly(1,6-hexylene terephthalate), poly(1,7-heptylene terephthalate), poly(1,8-octanylene terephthalate) poly(1,4-cyclohexylenedimethylene terephthalate) (PCT), copolymer thereof, and mixture thereof.

10. The recycled building material according to claim 1, in which the carbonyl-containing polymer comprises a poly(ethylene terephthalate) (PET) as shown below: 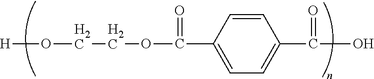
in which n is within a range from about 100 to about 200; Nylon of the formula: 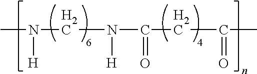
in which n is an integer; or a mixture of the PET and Nylon.

11. The recycled building material according to claim 1, in which the component (ii) polymer comprises reinforced fibers for roof/Geo membrane.

12. The recycled building material according to claim 1, in which the amount of the component (ii) polymer is from about 3% (wt) to about 10% (wt) based on the total weight of the recycled building material.

13. The recycled building material according to claim 1, in which the compatabilizer comprises a structural moiety miscible With the polyolefin.

14. The recycled building material according to claim 1, in which the compatabilizer comprises a copolymer of olefin monomers and/or a copolymer of conjugated diene monomers.

15. The recycled building material according to claim 14, in which the olefin monomer is selected from the group consisting of ethylene, propylene, butene or butylene, 1-butene, isobutylene, pentylene, 4-methyl-1-pentylene, hexene, heptene, octane, decene, and the mixture thereof; and the conjugated diene monomer is selected from the group consisting of 1,3-butadiene (1,3-Bd), isoprene (2-methyl-1,3-butadiene), 2-ethyl-1,3-butadiene, 2,3-dimethyl-1,3-butadiene, piperylene (1,3-pentadiene), 2-methyl-1,3-pentadiene, 3-methyl-1,3-pentadiene, 4-methyl-1,3-pentadiene, 2,4-dimethyl-1,3-pentadiene, 1,3-hexadiene, and the mixture thereof.

16. The recycled building material according to claim 14, which comprises an epoxy-containing monomer selected from the group consisting of glycidyl acrylate, glycidyl methacrylate, methyl glycidyl acrylate, methyl glycidyl methacrylate, 3,4-epoxycyclohexylmethyl acrylate, 3,4-epoxycyclohexylmethyl methacrylate, acrylic glycidyl ether, methacrylic glycidyl ether, and mixture thereof.

17. The recycled building material according to claim 1, in which the compatabilizer comprises a copolymer of olefin monomers, epoxy-containing monomers, and alkyl(meth)acrylate monomers.

18. The recycled building material according to claim 17, in which the alkyl(meth)acrylate monomer is selected from the group consisting of methyl acrylate, methyl methacrylate, ethyl acrylate, ethyl methacrylate, propyl acrylate, propyl methacrylate, butyl acrylate, butyl methacrylate, pentyl acrylate, pentyl methacrylate, hexyl acrylate, hexyl methacrylate, ethylhexyl acrylate, ethylhexyl methacrylate, and the mixture thereof.

19. The recycled building material according to claim 1, in which the compatabilizer comprises a ter-polymer of ethylene/methyl acrylate/glycidyl methacrylate (EMAGMA), a ter-polymer of ethylene/ethyl acrylate/glycidyl methacrylate (EEAGMA), a ter-polymer of ethylene/butyl acrylate/glycidyl methacrylate, a ter-polymer of ethylene/ethylhexyl acrylate/glycidyl methacrylate, or the mixture thereof.

20. The recycled building material according to claim 1, in which the compatabilizer comprises poly(ethylene-co-methyl acrylate-co-glycidyl methacrylate) (EMAGMA) as shown below: 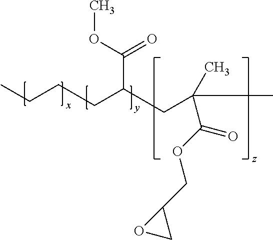
wherein x units are within a range from about 65 wt % to about 95 wt %, y units are within a range from about 0 wt % to about 30 wt %, and z units are within a range from about 0 wt % to about 8 wt %, based on the total weight of the copolymer.

21. The recycled building material according to claim 1, in which the compatabilizer comprises polybutadiene maleic anhydride (PBDMA).

22. The recycled building material according to claim 1, in which the amount of the compatabilizer is from about 1% (wt) to about 10% (wt) based on the total weight of the recycled building material.

23. An article of manufacture made from a recycled building material comprising (i) a polyolefin, (ii) a polymer containing a carboxyl group or a hydroxyl group, and (iii) a compatabilizer for the components (i) and (ii) which contains an epoxy group or an anhydride group.

24. The article of manufacture according to claim 23, which is a TPO membrane product and the recycled building material is recycled TPO.

25. The TPO membrane product according to claim 24, in which the amount of the recycled TPO is from about 85% (wt) to about 95% (wt) based on the total weight of the TPO membrane product.

26. A method of recycling building material, comprising the steps of (i) providing a first building material comprising a polyolefin, (ii) providing a second building material comprising a polymer containing a carboxyl group, an amide group, or a hydroxyl group, (iii) providing a compatabilizer which contains an epoxy group or an anhydride group for the polyolefin and the polymer containing a carboxyl group or a hydroxyl group, and (iv) melting and mixing the first building material, the second building material, and the compatabilizer.

27. The method of recycling building material according to claim 26, in which the first building material comprises TPO membrane used for the top ply or the bottom ply in a roof, and the second building material comprises PET fibers from the scrim for the TPO membrane reinforcement.

28. The method of recycling building material according to claim 26, in which the melting and mixing in step (iv) is conducted in a mixing apparatus selected from the group consisting of a Brabender mixer or a Brabender plastograph, a two-stem mixer, a twin-screw extruder, a single-screw extruder, a plastomill or a rubber mill, a Banbury mixer, a Buss-Ko kneader, a Farrel continuous mixer, a kneader, a static mixer, an impingement mixer, and combination thereof.
